(19) United States
(12) Patent Application Publication
(10) Pub. No.: US 2017/0119626 A1
(43) Pub. Date: May 4, 2017

(54) Travel Packaging For Medications

(71) Applicant: Satish Poddar, Duluth, GA (US)

(72) Inventor: Satish Poddar, Duluth, GA (US)

(21) Appl. No.: 14/926,068

(22) Filed: Oct. 29, 2015

(51) Int. Cl. A61J 1/03; B65D 75/54; B65D 75/36; B65B 5/06; B65B 7/16

(52) U.S. Cl. CPC A61J 1/035; B65B 5/06; B65B 7/16; B65D 75/367; B65D 75/54

(57) ABSTRACT

The present disclosure provides a medical product package for use at a travel destination. The medical product package may include a first medical product stored in a first cavity and a second medical product stored in a second cavity. At least one of the first medical product and the second medical product may be determined based, at least, on the travel destination. In some aspects, the first medical product and the second medical product may be in pill form. The medical product package may be embodied as a blister package including a substrate and a plurality of sealed blister cavities disposed on the substrate. The first cavity may comprise at least one of the plurality of sealed blister cavities and the second cavity may comprise at least another one of the plurality of sealed blister cavities.

### TECHNICAL FIELD

The technical field relates generally to medication packaging and more particularly to travel packaging for medications.

### BACKGROUND

Many people enjoying travelling to other parts of the world to see new sights and enjoy the local culture. Similarly, the modern business world requires many workers to travel abroad to investigate a potential new market or meet a foreign client, for example. Visiting a new locale, however, may expose a traveler to novel circumstances or environments which may adversely affect the traveler's health. For instance, the water purification technology used at a travel destination may be less advanced than that of a traveler's home city. When the traveler drinks the water at the travel destination, the traveler may be exposed to bacteria, parasites, or other pathogens that the traveler's immune system is unaccustomed to handling. As another example, certain diseases, such as malaria, may be common in some regions of the world. When a traveler visits one of those regions, the traveler may be exposed to those diseases to which the traveler might not have otherwise been exposed. It is not uncommon for a particular travel destination to be associated with several such factors that may each adversely affect a traveler's health. Moreover, even ailments common in a traveler's home country may strike when at a travel destination.

In order to allow a traveler to respond, while on the trip, to such adverse health conditions caused by various aspects of a travel destination, a health care provider may supply a medication for each of the potential health conditions. The traveler may carry each of the separate medications with him or her to the travel destination. Carrying each of the medications in separate packaging, such as in separate bottles or blister packs, may prove cumbersome and space-consuming for the traveler, however.

### SUMMARY

Disclosed herein is a medical product package for use at a travel destination. The medical product package may include a first medical product stored in a first cavity and a second medical product stored in a second cavity. The first cavity and the second cavity may be connected. At least one of the first medical product and the second medical product may be determined based, at least, on the travel destination. In some aspects, the first medical product and the second medical product may be in pill form. The medical product package may be embodied as a blister package including a substrate and a plurality of sealed blister cavities disposed on the substrate. The first cavity may comprise at least one of the plurality of sealed blister cavities and the second cavity may comprise at least another one of the plurality of sealed blister cavities.

Also disclosed herein is a method for making a medical product package for use at a travel destination. The method may include determining a first medical product and a second medical product each based, at least, on the travel destination. The method may further include disposing the first medical product and the second medical product within the medical product package. The first cavity and the second cavity may be connected. The method may include sealing the first cavity and the second cavity. In some aspects, the method may further include determining a first medical condition and a second medical condition each relating to the travel destination. The first and second medical products may be further determined based, at least, on the first and second medical conditions, respectively.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates a front view of an exemplary travel package for medications or other medical products;

FIG. 2 illustrates a rear view of an exemplary travel package for medications or other medical products;

FIG. 3 illustrates a front view of an exemplary travel package for medications or other medical products;

FIG. 4 illustrates a front view of an exemplary travel package for medications or other medical products; and

FIG. 5 illustrates a method of making a travel package for medications or other medical products.

### DETAILED DESCRIPTION OF ILLUSTRATIVE EMBODIMENTS

Described herein is travel packaging for medications that may provide a convenient, all-in-one package for all or many of the medications or other medical products that are anticipated to be needed by a patient while on a trip. The package may be provided by a health care provider, such as a pharmacist or physician, to a patient in preparation for a trip by the patient to a particular travel destination. The package may include one or more medications or other medical products. One or more of the medications or other medical products included in the package may be determined by the health care provider according to the travel destination. For example, a medication for the treatment of malaria may be included in the package on the basis of the travel destination being a certain tropical region in which malaria is prevalent. The package may then be taken by the patient on his or her trip to the travel destination wherein the medical products may be used, if needed.

In describing embodiments of the present disclosure illustrated in the figures, specific terminology is employed for the sake of clarity. The disclosure, however, is not intended to be limited to the specific terminology so selected, and it is to be understood that each specific element includes all technical equivalents that operate in a similar manner to accomplish a similar purpose.

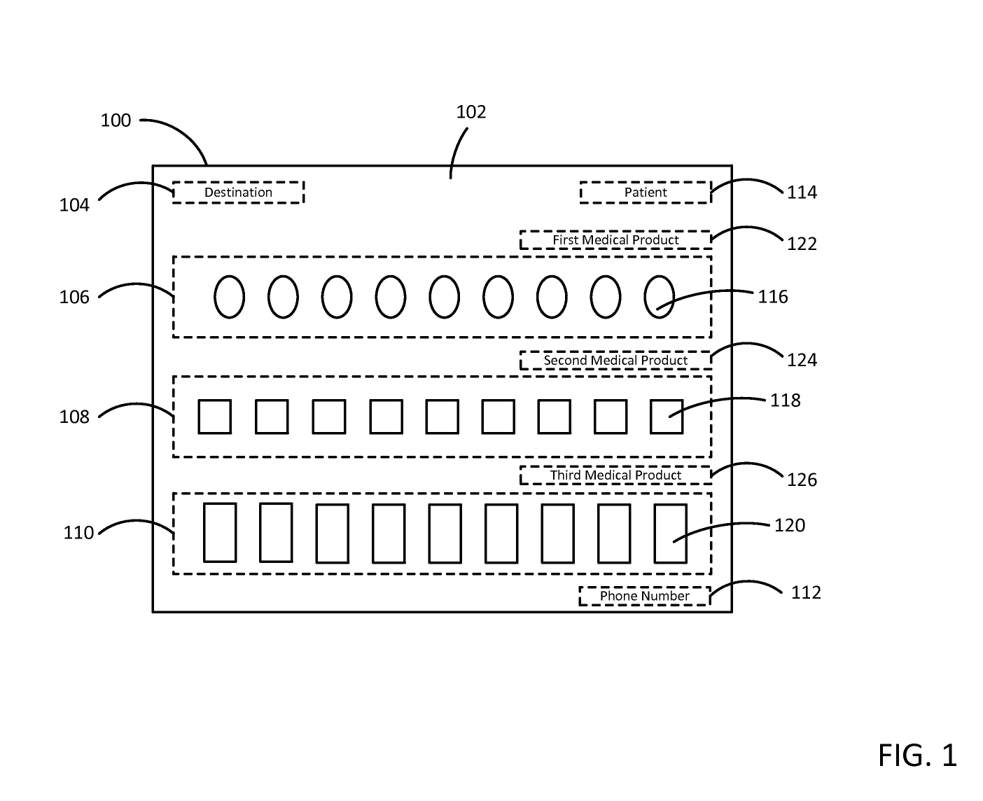

FIG. 1 depicts a front view of an exemplary embodiment of a package 100 for one or more medical products. As used herein, the term “medical product” may refer to a pharmaceutical drug (e.g., an ingestible pill, an ingestible liquid solution, a topical cream or ointment, an ear drop, an eye drop, an inhalant, etc.) or a medical device (e.g., a bandage, a swab, medical gloves, a scalpel, forceps, etc.). The medical product may be a prescription medical product or an over-the-counter medical product.

The package 100 may be embodied as a blister package, such as depicted in FIG. 1, configured to securely contain one or more medical products. The package 100 may include a substrate 102, such as cardboard or plastic, defining a plurality of sealed blister cavities in which each cavity may secure a dose (e.g., a pill) of a medical product and be individually sealed such that the seal is broken to access the medical product. The backing of each cavity may be comprised of a thin material, such as foil, through which the medical product in the cavity may be pushed by the user to expel the medical product from the package 100.

In an aspect, each of the sealed blister cavities may be sterile. The cavities containing the medical products may be arranged in one or more regions, such as a first region 106, a second region 108, and a third region 110. The medical product contained in each region may be a different medical product from the medical products contained in the other regions. For example, the first region 106 may include a first medical product 116, the second region 108 may include a second medical product 118, and the third region 110 may include a third medical product 120. For sake of visual clarity, not all of the first medical product 116, the second medical product 118, and the third medical product 120 are labeled in FIG. 1. The package 100 may include a label identifying the medical product disposed within a certain region. For example, the package 100 may include a first medical product label 122 identifying the first medical product 116 in the first region 106, a second medical product label 124 identifying the second medical product 118 in the second region 108, and a third medical product label 126 identifying the third medical product 120 in the third region 110. In an aspect, the medical products, such as the first medical product 116, the second medical product 118, and/or the third medical product 120, may each have an identical or nearly identical expiration date, thus preventing a situation in which one of the medical products is expired while one or more of the other medical products are not expired.

The medical products included in the package 100, such as the first medical product 116, the second medical product 118, or the third medical product 120, may each be determined according to a travel destination (e.g., a city, country, continent, or region), such as a travel destination contemplated by the patient. In particular, the medical products may be determined based on one or more factors associated with the travel destination. A factor associated with the travel destination may include an infrastructure factor, an environmental factor, a flora/fauna factor, a travel factor, or a common disease factor.

An infrastructure factor may refer to any aspect of the travel destination's infrastructure which may cause or contribute to an adverse health effect in the patient. For example, an infrastructure factor may include an indication that the water treatment system of the travel destination has a lesser or different degree of efficacy compared to that of the locale from which a patient is traveling. To illustrate, a patient traveling to a less developed country with poor or no water treatment facilities may suffer from diarrhea caused by pathogens in the water supply. An infrastructure factor may further relate to the sewer system in place at the travel destination. For instance, if the travel destination has only an open sewer system with no sewer treatment facilities, this may put a patient at increased risk of waste-borne illnesses.

An environmental factor may refer to any aspect of the travel destination's environment that may cause or contribute to an adverse health effect in the patient. As one example, an environmental factor may indicate that the travel destination suffers from severe air pollution. The air pollution may, for example, exasperate an asthma condition of the patient or put the patient at increased risk of respiratory distress or infection. An environmental factor may include an indication of a weather condition of the travel destination. For instance, an environmental factor may include an indication that the sun is particularly intense at the travel destination and, therefore, the patient may be easily sunburned. As another example, an environmental factor may indicate that the travel destination is particularly hot or cold. As yet another example, the environmental factor may include an indication that the travel destination contains certain allergens.

A flora/fauna factor may include an aspect of the travel destination pertaining to a macroscopic plant or animal within the travel destination that may harm the patient. For examples, a flora/fauna factor may include an indication that the travel destination is host to jellyfish, mosquitoes or other biting insects, or venomous snakes. A flora/fauna factor may further include an indication of an animal that may cause a parasitic invasion of the patient's body, such as guinea worms, intestinal worms, or botflies. As yet another example, a flora/fauna factor may include an indication that the travel destination has poison ivy.

A travel factor may refer to any aspect of the act of traveling, such as to the travel destination, that may cause or contribute to an adverse health effect of the patient. The travel factor may include an indication of a mode of travel, such by car, ship, airplane, or train. For example, traveling on an ocean-going ship may cause some individuals to experience the nausea and dizziness associated with sea-sickness. Further, the travel factor may include an indication that an individual is exposed to a high concentration of other people in a confined space, such as in a train or airplane, which may increase the individual's chances of contracting a communicable disease, such as sinusitis or pharyngitis. The travel factor may include an indication that an individual is at an increased risk of dehydration due to traveling. The dehydration may, in turn, put the individual at an increased risk of other conditions or diseases, such as a urinary tract infection.

A common disease factor may refer to an aspect of the travel destination relating to a disease, illness, condition, etc., that commonly affects individuals at the travel destination. For example, certain diseases, such as malaria or dengue fever, may be prevalent in tropical or subtropical regions throughout the world. Others, such as chagas disease, may be prevalent in the tropical or subtropics regions of Central and South America.

It will be appreciated that the medical products included in the package 100 may include not only those medical products that directly treat a condition caused by or otherwise related to one of the aforementioned factors, but may also include medical products that treat secondary effects of the condition or provide supportive treatment. For example, if the patient is traveling to a region in which malaria is common, the package 100 may include not only an antimalarial medication but also a medication to reduce fever and/or a medication to relieve pain. In some aspects, the medical products included in the package 100 may include medical products corresponding to a partial treatment for a particular disease or medical condition, or symptom thereof. For example, the package 100 may include a number of pills comprising a half-dose of the medical product. This may provide temporary relief or treatment to the patient until the patient can locate a health care provider at the travel destination, while still allowing the package 100 to remain compact due to the inclusion of only the partial dosage instead of a full dosage.

The medical products included in the package 100, such as the first medical product 116, the second medical product 118, or the third medical product 120, may additionally be based on the individual medical needs of the patient. This may include a consideration of the medical needs of the patient notwithstanding the patient's travel or the travel destination, such as a medical product that the patient is already taking before the trip. For example, a patient may suffer from high-blood pressure, in which case the package 100 may include the patient's usual blood pressure medication along with other medical products determined according to the travel destination. The individual medical needs of the patient may also include those medical needs which may address conditions commonly experienced by the patient, but which the patient does not already suffer from and are unrelated to the travel destination. For example, the package 100 may include a medical product that treats a common cold, a sinus infection, acid reflux, urinary tract infection, or minor pains. In this manner, the patient may be provided with a single, convenient travel package that may fulfill the patient's medical needs—both known and contemplated—while the patient is traveling.

The package 100 may further include a destination label 104 indicating the travel destination according to which one or more of the medical products has been determined The package 100 may also include a patient label 114 indicating the patient for whom the package is prepared. The package 100 may include a phone number 112. The phone number 112 may correspond with a medical help line in which the patient may solicit directions or information concerning the medical products and the conditions that the medical products may address. The package 100 may include a website address (e.g., a uniform resource locator (URL)) pointing to a website at which the patient receive may receive information concerning the medical condition afflicting the patient or the medical products. In an aspect, the website may facilitate a real-time consultation with a health care provider (a “virtual visit”).

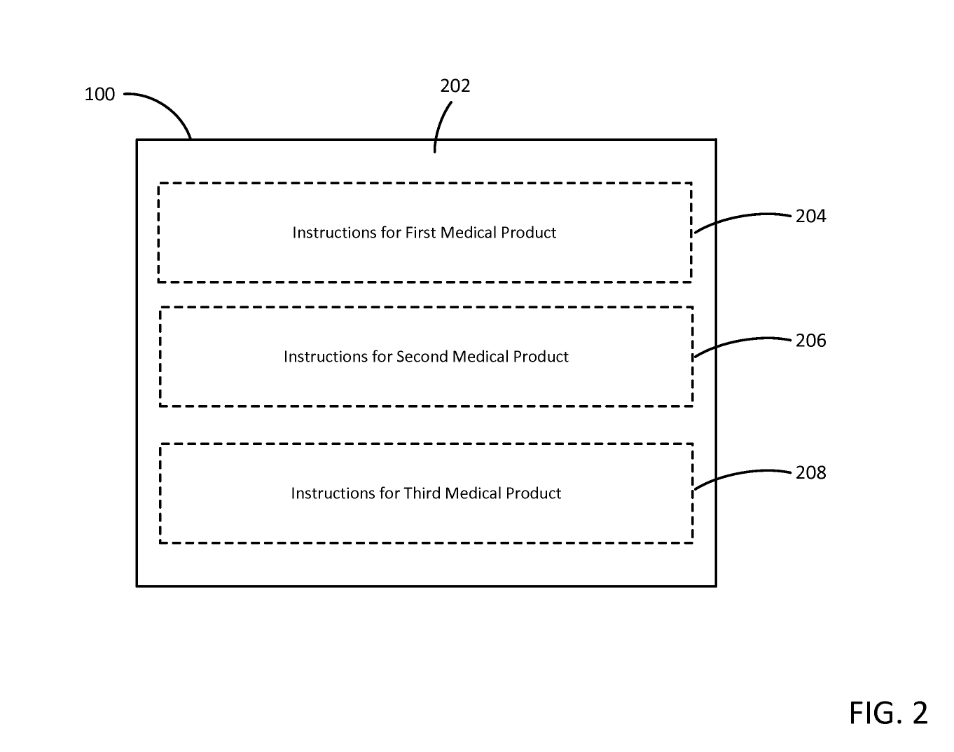

FIG. 2 depicts a rear view of the package 100. The package 100 may include one or more instruction regions in which instructions (e.g. dosage information) or other information (e.g., medical conditions or symptoms that the medical product addresses or side effects of the medical product) about the medical products may be provided. Additionally or alternatively, each instruction region may include the name or another identifier of the corresponding medical product. Each instruction region may correspond with one of the medical products included in the package 100. For example, a first instruction region 204 may correspond with the first medical product 116, a second instruction region 206 may correspond with the second medical product 118, and the third instruction region 208 may correspond with the third medical product 120.

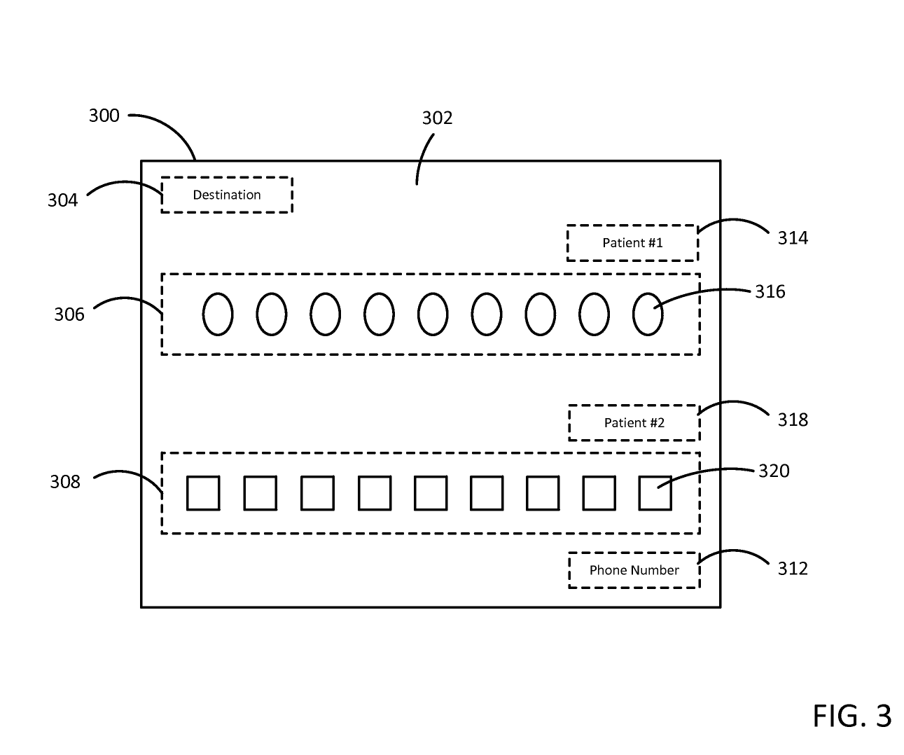

FIG. 3 depicts an alternative embodiment in which a package 300 may include medical products intended for use by more than one patient, such as a family of patients. Like the package 100 depicted in FIG. 1, the package 300 may be embodied as a blister pack including a substrate 302 defining a plurality of sealed blister cavities. Each cavity may secure a dose (e.g., a pill) of a medical product. The cavities may be arranged in one or more regions, such as a first region 306 and a second region 308. Each region may be associated with a different patient (e.g., the medical product contained in a region are intended for use by a particular patient) and labeled as such. For instance, the first region 306 may be associated with a first patient and a first patient label 314 identifying the first patient may be positioned on the package 300 proximate to the first region 306. The second region 308 may be associated with a second patient and a second patient label 318 may be positioned on the package 300 proximate to the second region 308.

The medical products, such as a first medical product 316 disposed with the first region 306 and a second medical product 320 disposed within the second region 308, intended for the patients may be different medical products or the same medical product but in different dosages. The medical products included in the package 300 may be determined according to the factors described herein, but also according to the number of patients and their individual attributes, such as age, sex, and weight. As an example of an embodiment of the package 300 in which the medical products are the same medical product in different dosages, the first patient and the second patient may intend to go on a trip to a country that has poor water sanitation that may be likely to cause diarrhea. Accordingly, the package 300 may include an anti-diarrhea medication, such as loperamide, as the first medical product 316 and the second medical product 320. Since the first patient may weigh more than the second patient, each loperamide pill of the first medical product 316 may be in a higher dose than those of the second medical product 320.

The package 300 may include a destination label 304 indicating the travel destination according to which one or more of the medical products may be determined The package 300 may further include a phone number 312 corresponding to a medical help line. The package 300 may include a website address (e.g., a URL) to a website at which the patient may receive information about the medical products or medical conditions or engage in a real-time consultation with a health care provider (a “virtual visit”). Alternatively, a single dimensional or multi-dimensional barcode or other scannable indicia may be provided on the package to be scanned by a smart phone or other device to access relevant information. The package may include multiple barcodes or other scannable indicia for each type of product or for each dose such that a traveler may scan the index prior to breaking the seal of any individual cavity. The information from the scan may then be stored in the smart phone or other device for later retrieval so that the patient and the health care professional can audit the types and amounts of medical products accessed and consumed. Alternatively, the smart phone or other device may communicate such information to a website or other server to be accessed by the traveler or a physician in either real time or at a later date. A questionnaire associated with the scanned indicia may be completed by the traveler to facilitate the virtual visit. Such tracking will assist the health care professional to monitor the traveler for progress and enable the health care professional to change the prescription or dosage as part of follow-up virtual visits during the course of travel. Such scannable index may, for example, be a 2-D barcode readable by a handheld scanner or smart phone application used for other technologies as is known by those skilled in the art.

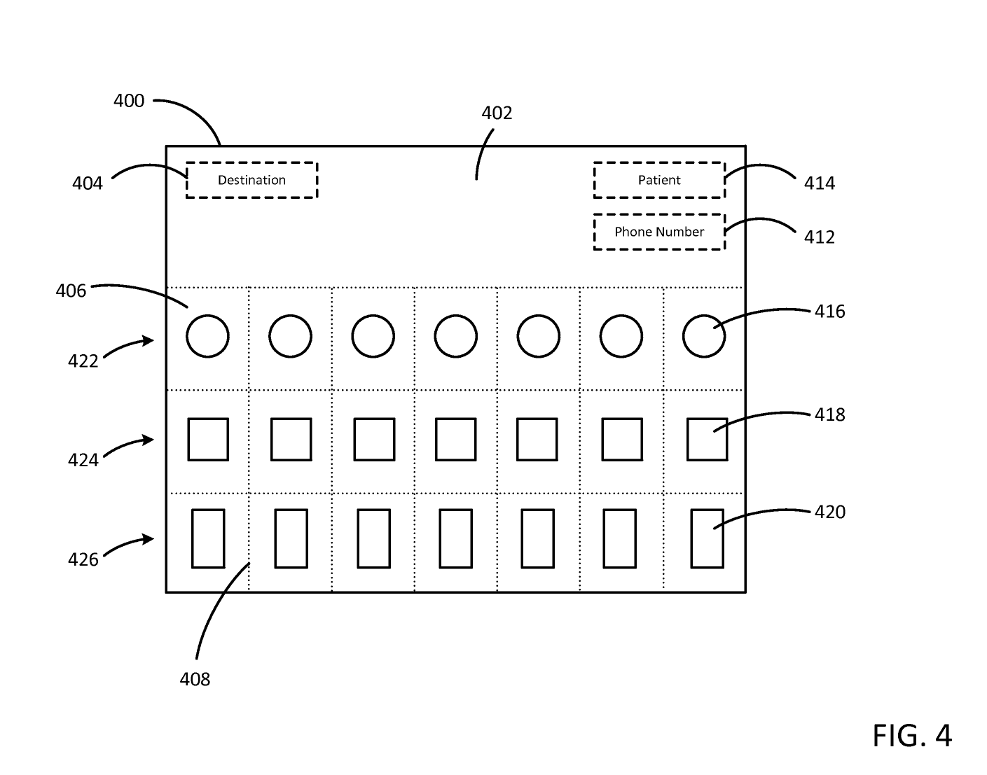

FIG. 4 depicts another alternative embodiment in which a package 400 may include a perforated sheet 402 comprising a plurality of packets 406. Each of the packets 406 may be defined by a perforated edge 408 and connected via at least one perforated edge 408 with at least one other packet 406. Each of the packets 406 may contain a pill or other dosage of a medical product. Each packet 406 may include a top layer peripherally adhered to a bottom layer to form a sealed cavity between the top layer and the bottom layer. The top and bottom layers may be composed of paper, thin plastic, foil, or a combination thereof. In use, one of the packets 406 may be separated from the package 400 along its perforated edge(s) 408, and the packet 406 may be ripped open. Alternatively, the bottom and top layers may be peeled apart to allow access to the pill or other form of the medical product contained therein.

The packets 406 may be arranged according to the medical product contained therein. For example, a dose (e.g. a pill) of a first medical product 416 may be contained in each of the packets 406 in a first row 422 of the package 400, a dose of a second medical product 418 may be contained in each of the packets 406 of a second row 424 of the package 400, and a dose of a third medical product 420 may be contained in each of the packets 406 of a third row 426 of the package 400.

The package 400 may include a destination label 404 indicating the travel destination according to which one or more of the medical products may be determined The package 400 may further include a patient label 414 identifying the patient or a phone number 412 corresponding to a medical help line.

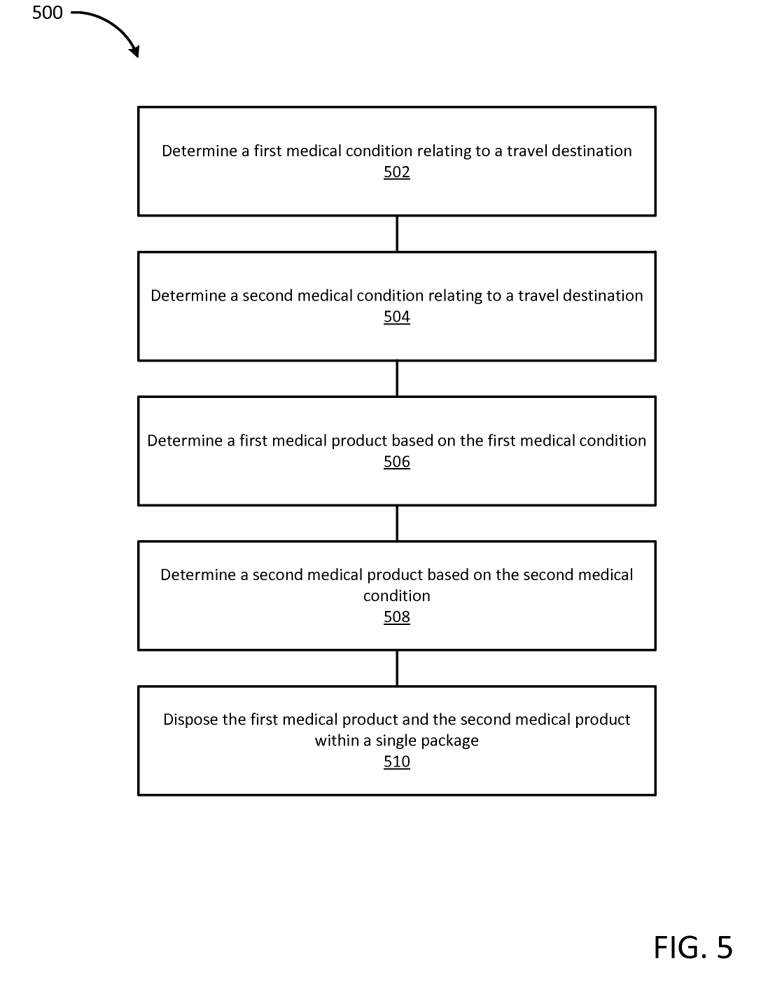

FIG. 5 depicts a method 500 for assembling a travel package containing medical products for use while a patient visits a travel destination. At step 502, a first medical condition relating to the travel destination may be determined At step 504, a second medical condition relating to the travel destination may be determined A medical condition may include an illness, a disease, an injury, or a medical symptom. The first and second medical conditions may each include a medical condition that the patient is more likely to suffer from at the travel destination than at the patient's home locale. The first and second medical conditions may each be determined based, at least, on one or more factors associated with the travel destination, such as an infrastructure factor, an environmental factor, a flora/fauna factor, or a common disease factor, as discussed in detail above.

As an example, the patient may intend to take a trip to Panama. The first medical condition may be determined to be dengue fever according to a common disease factor indicating that dengue fever is common in Panama. The second medical condition may be determined to be insect bites based on a flora/fauna factor indicating that there are a high number of biting insects in Panama.

At step 506, a first medical product, such as the first medical product 116, may be determined based, at least, on the first medical condition of step 502. At step 508, a second medical product, such as the second medical product 118, may be determined based, at least, on the second medical condition of step 504. The first and second medical products may be medical products that may treat or otherwise address the first and second medical conditions, respectively, or symptom thereof. The first medical product and/or the second medical product may further be determined based on an age, weight, and/or gender of the patient. The packaging and associated medical products may be configured for an individual, a family, or a group of individuals traveling together.

Continuing the Panama trip example, the first medical product may be a medical product that alleviates the symptoms of dengue fever, the first medical condition. Accordingly, the first medical product may be acetaminophen pills for managing the fever and pain caused by the dengue fever. The second medical product may be a medical product for treating insect bites, the second medical condition. Therefore, the second medical product may be diphenhydramine (e.g., Benadryl®) pills to reduce the itching of the insect bites.

At step 508, the first medical product of step 506 and the second medical product of step 508 may be packaged within a single package, such as the package 100, the package 300, or the package 400. As depicted in FIG. 1, the package 100 may be embodied as a blister package. In other embodiments, the package 100 may comprise a box, casing, clamshell, carton, shrink wrap, or formed plastic package. The first medical product may be secured in a first set of one or more sealed blister cavities, such as those included in the first region 106 of the package 100. The second medical product may be secured in a second set of one or more sealed blister cavities, such as those included in the second region 108 of the package 100. Each of the medical products may be secured with its own seal such that the medical products cannot be mixed or confused and configured such that only an individual seal is broken each time a single medical product is accessed. As such, the number and types of medical products consumed can be controlled and audited. The number of pills or other measure of dosage of the first and second medical products disposed within the package 100 may be determined according to an intended length of time of the trip to the travel destination. Additionally or alternatively. the package 100 may include an amount of the first and second medical products for a certain period of time (e.g., a day, a week, etc.), and a number of the packages 100 provided to a patient may depend upon the total intended length of the trip. For example, if a patient is planning to spend four weeks at the travel destination, the patient may be provided 28 daily packages 100 or 4 weekly packages 100.

Continuing the Panama trip example, the acetaminophen pills (i.e., the first medical product) and the diphenhydramine pills (i.e., the second medical product) may be included in a single blister package. The acetaminophen pills may be situated in a first region of the blister package and the diphenhydramine pills may be situated in a second region of the blister package. The single blister package may be taken by the patient on the patient's trip to Panama, thus providing a single medication package that the patient need pack and keep track of

One or more or steps of the method 500 may be performed by one or more of a physician or other medical care provider, a pharmacist, or a third party (i.e., a party other than a physician or pharmacist), such as a drug manufacturer. For example, a physician may determine the medical conditions that the patient may suffer from while at the travel destination and determine the medical products appropriate to address those medical conditions. The physician may possess a means for packaging and may accordingly package the determined medical products in a single package. In an aspect, a pharmacist may receive an indication of the medical products determined by the physician and the pharmacist may produce the package including the medical products.

As another example, a third party, such as a drug manufacturer, may determine the medical conditions that an individual (i.e., not a specific patient) may experience while visiting a particular travel destination and determine the medical products that may address those medical conditions. The third party may package the determined medical products in single packages and distribute the single packages to physicians, pharmacists, retailers, etc., for later distribution to patients. In other words, the packages may be pre-packed by the third party according to travel destination or the other factors mentioned herein. A physician, for example, may provide or prescribe a pre-packaged package for India to a patient that is planning a trip to India.

While the disclosure has been described in connection with the various embodiments of the various figures, it is to be understood that other similar embodiments can be used or modifications and additions can be made to the described embodiments. Therefore, the travel packaging for medications as described herein should not be limited to any single embodiment, but rather should be construed in breadth and scope in accordance with the appended claims.

1. A medical product package for a travel destination, the medical product package comprising:
a first cavity;
a second cavity physically connected to the first cavity;
a first medical product sealed in the first cavity; and
a second medical product sealed in the second cavity, wherein a seal of the first cavity must be broken to access the first medical product and a seal of the second cavity must be broken to access the second medical product, and at least one of the first medical product and the second medical product is selected based at least in part on the travel destination.

2. The medical product package of claim 1, wherein:
the first medical product comprises a first set of one or more pills; and
the second medical product comprises a second set of one or more pills, wherein each of the one or more pills is sealed in its own cavity.

3. The medical product package of claim 2, wherein:
the medical product package comprises a blister package, the blister package comprising a substrate and a plurality of sealed blister cavities disposed on the substrate; and
the first cavity comprises at least one of the plurality of sealed blister cavities.

4. The medical product package of claim 2, wherein:
the medical product package comprises a perforated sheet, the perforated sheet comprising a plurality of sealed packets; and
the first cavity comprises at least one of the plurality of sealed packets.

5. The medical product package of claim 1, further comprising at least one of:
a phone number via which a user obtains professional medical advice from a home-country medical professional of the user, the professional medical advice relating to at least one of the first medical product or the second medical product; or
a web address via which the user obtains professional medical advice from the home-country medical professional of the user, the professional medical advice relating to at least one of the first medical product or the second medical product.

6. The medical product package of claim 1, wherein the first medical product is a pharmaceutical drug and the second medical product is a medical device.

7. The medical product package of claim 1, wherein at least one of the first medical product and the second medical product is selected based, at least, on a medical condition present at the travel destination.

8. The medical product package of claim 1, wherein at least one of the first medical product and the second medical product is selected based, at least, on an aspect of the travel destination relating to at least one of an environment of the travel destination, macroscopic flora at the travel destination, macroscopic fauna at the travel destination, and an infrastructure of the travel destination.

9. The medical product package of claim 1, wherein:
the first medical product is selected based, at least, on the travel destination; and
the second medical product is selected based, at least, on a medical need of a traveler to the travel destination, the medical need being unrelated to the travel destination.

10. The medical product package of claim 1, wherein:
the first medical product is intended for use by a first traveler to the travel destination;
the second medical product is intended for use by a second traveler to the travel destination; and
the first medical product and the second medical product are the same medical product, wherein a dosage of the first medical product is different than a dosage of the second medical product.

11. A method of making a medical product package, the method comprising:
determining a first medical product based on at least a travel destination;
determining a second medical product based on at least the travel destination;
disposing the first medical product within a first cavity of the medical product package and disposing the second medical product within a second cavity of the medical product package, the first cavity and the second cavity being connected; and
sealing the first cavity and the second cavity.

12. The method of claim 11, further comprising:
determining a first medical condition relating to the travel destination, wherein the first medical product is further determined based on at least the first medical condition;
determining a second medical condition relating to the travel destination, wherein the second medical product is further determined based on at least the second medical condition.

13. The method of claim 11, wherein:
the first medical product comprises a first set of one or more pills; and
the second medical product comprises a second set of one or more pills.

14. The method of claim 13, wherein the medical product package comprises a blister package, the blister package comprising a substrate and a plurality of sealed blister cavities disposed on the substrate, wherein the first cavity and the second cavity each comprise one or more of the plurality of sealed blister cavities.

15. The method of claim 14, wherein:
the first cavity comprises at least two of the plurality of sealed blister cavities such that each pill of the first set of one or more pills is disposed, in a first region defined on the substrate, within a sealed blister cavity of the plurality of sealed blister cavities; and
the second cavity comprises at least another two of the plurality of sealed blister cavities such that each pill of the second set of one or more pills is disposed, in a second region defined on the substrate, within a sealed blister cavity of the plurality of sealed blister cavities.

16. The method of claim 13, wherein:
the medical product package comprises a perforated sheet, the perforated sheet comprising a plurality of sealed packets; and
the first cavity comprises at least one of the plurality of sealed packets.

17. The method of claim 11, wherein the medical product package further comprises at least one of:
a phone number via which a user obtains professional medical advice from a home-country medical professional of the user, the professional medical advice relating to at least one of the first medical product or the second medical product; or
a web address via which the user obtains professional medical advice from the home-country medical professional of the user, the professional medical advice relating to at least one of the first medical product or the second medical product.

18. The method of claim 12, wherein the determining the first medical condition relating to the travel destination is further based on an aspect of the travel destination relating to at least one of an environment of the travel destination, macroscopic flora at the travel destination, macroscopic fauna at the travel destination, or an infrastructure of the travel destination.

19. The method of claim 11, further comprising:
determining a third medical product based on at least a medical need of a traveler to the travel destination, the medical need being unrelated to the travel destination; and
disposing the third medical product within the medical product package.

20. The method of claim 11, wherein:
the first medical product is designated for use by a first traveler to the travel destination;
the second medical product is designated for use by a second traveler to the travel destination; and
the first medical product and the second medical product are the same medical product, wherein a dosage of the first medical product is different than a dosage of the second medical product.

21. The method of claim 1, wherein the travel destination comprises at least one of a city, a country, or a continent.
